(19) United States
(12) Patent Application Publication
(10) Pub. No.: US 2007/0251647 A1
(43) Pub. Date: Nov. 1, 2007

(54) Manual label dispenser

(76) Inventor: Harrison Huang, Taichung Hsien (TW)

Correspondence Address: BACON & THOMAS, PLLC, 625 SLATERS LANE, FOURTH FLOOR, ALEXANDRIA, VA, 22314, US

(21) Appl. No.: 11/411,118

(22) Filed: Apr. 26, 2006

(51) Int. Cl. B44C 7/00; B29C 63/00

(52) U.S. Cl. 156/577; 156/584

(57) ABSTRACT

A manual label dispenser includes a housing having a first sidewall and a second sidewall. The first sidewall has an opening. The second sidewall has a rear neck portion associated with the opening of the first sidewall and an opening beside the rear neck portion. A label peering device is mounted on the housing between the first sidewall and the second sidewall. A roll has an end mount fixed to the rear neck portion of the second sidewall and an opposite end suspended, whereby a label roll is mounted on the roll via the opening of the first sidewall.

### BACKGROUND OF THE INVENTION

1. Field of the Invention

The present invention relates generally to adhesive label, and more particularly to a manual label dispenser.

2. Description of the Related Art

The self-adhesive labels are held on the releasing paper and on a reel. The label dispenser is used to facilitate the removing of the releasing paper so as to attach the label on an object.

A conventional label dispenser includes a housing in which a roll mount is provided to mount the label roll thereon. The housing includes two upright plates, between which the roll mount is provided. The roll mount includes several shafts arranged in a curved pattern so as to rest the label roll for free rotation. The roll mount also includes a plate with several bores mounted on the shafts. The plate may be shifted along the shafts to press the label roll, thus the label roll is positioned for rotation only.

In fact, the plate of the roll mount only provides a weak power to position the label roll. The label roll still may lean or escape from the roll mount when user pulls the label out.

### SUMMARY OF THE INVENTION

The primary objective of the present invention is to provide a manual label dispenser, which the label roll is easy to mount on the dispenser and take off also. In addition, the label roll is mounted on the dispenser firmly.

According to the objective of the present invention, a manual label dispenser includes a housing having a first sidewall and a second sidewall. The first sidewall has an opening, and the second sidewall has a rear neck portion associated with the opening of the first sidewall. A label peering device is mounted on the housing between the first sidewall and the second sidewall. A roll has an end mount fixed to the rear neck portion of the second sidewall and an opposite end suspended, whereby a label roll is mounted on the roll via the opening of the first sidewall.

### BRIEF DESCRIPTION OF THE DRAWINGS

FIG. 1 is a perspective view of a preferred embodiment of the present invention;

FIG. 2 is a back view of the preferred embodiment of the present invention;

FIG. 3 is a sectional view of the preferred embodiment of the present invention; and

FIG. 4 is a perspective view of the preferred embodiment of the present invention, showing how to mount the label to the label peering device.

### DETAILED DESCRIPTION OF THE INVENTION

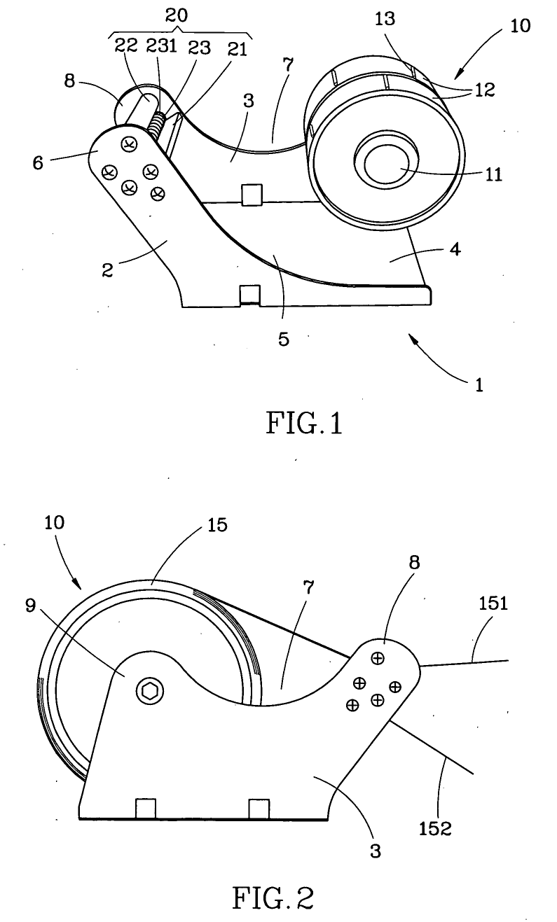

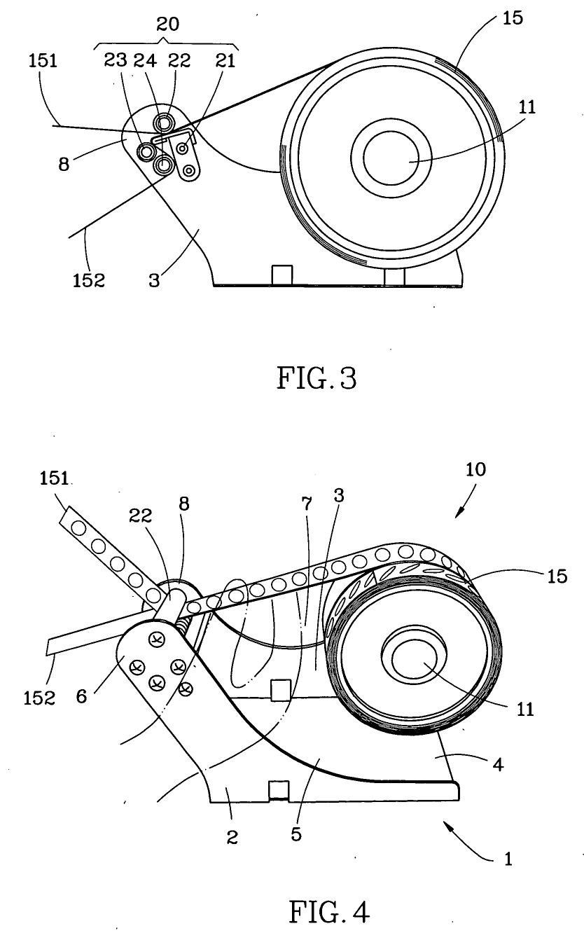

As shown in FIG. 1 to FIG. 4, a manual label dispenser of the preferred embodiment of the present invention comprises:

A housing 1 includes a first sidewall 2, a second sidewall 3 and a bottom wall 4. The first and second sidewalls 2 and 3 are two parallel upright plates, and the bottom wall 4 is connected to bottom of the first and second sidewalls 2 and 3. The first sidewall has an opening 5 at middle and rear thereof and a front neck portion 6 at a front thereof. The second sidewall 3 has an opening 7 at a middle and a front neck portion 8 and a rear neck portion 9 at opposite sides of opening 7.

A roll mount 10 has a shaft 11 and two reels 12. The reels 12 are fitted to the shaft 11 for rotation independently so as to mount two label rolls 12 thereon. The shaft 11 has an end fixed on the rear neck portion 9 of the second sidewall 3 and the other end suspended. The label rolls 12 may be mounted onto the reels 12 via the opening 5 of the first sidewall 2. The reels 12 have ribs 13 on circumferences to fit the label rolls 12 in an interference fitness.

A label peering device 20, which is mounted on the front neck portions 6 and 8 of the sidewalls 2 and 3, includes a guiding plate 21, an upper shaft 22 at a top side of the guiding plate 21, a separating shaft 23 at a front side of the guiding plate 21, a spiral member 231 fitted to the separating shaft 23, a lower shaft 24 under the guiding plate 21. The label roll 15 has a label strip 151 and a base strip 152. To mount the label strip 151 and a base strip 152 on the label peering device 20, the label strip 151 and the base strip 152 are inserted into a gap between the upper shaft 22 and the guiding plate 21, and then the base strip 152 goes under the separating shaft 23 through a gap between the separating shaft 23 the guiding plate 21 and wings around the lower shaft 24. The label strip 151 goes up to be drawn by user. The label peering device 20 is a conventional device, one may find the detail in many inventions.

The label dispenser of the present invention provides a suspended roll mount 10 so as to mount (or take off) the label roll 15 thereon via the opening 5. The replacement of the label roll is faster. The label roll is mounted on the reel of the roll mount in interference fitness, in other words, the label roll is mounted on the dispenser firmly. In addition, the openings 5 and 7 of the sidewalls 1 and 2 also help user to mount the label strip 151 and the base strip 152 of the label roll 15 to the label peering device 20 no matter you are a right-handed user or a left-handed user.

The description above only includes few preferred embodiments and the equivalence of the present invention is still in the scope of the claim of the present invention.

What is claimed is:

1. A manual label dispenser, comprising:
a housing having a first sidewall and a second sidewall, wherein the first sidewall has an opening, and the second sidewall has a rear neck portion associated with the opening of the first sidewall;
a label peering device mounted on the housing between the first sidewall and the second sidewall; and
a roll having an end mount fixed to the rear neck portion of the second sidewall and an opposite end suspended, whereby a label roll is mounted on the roll via the opening of the first sidewall.

2. The manual label dispenser as defined in claim 1, wherein the opening of the first wall is located at a rear and a middle of the first sidewall.

3. The sawing machine as defined in claim 1, wherein the second sidewall of the housing has an opening.

4. The sawing machine as defined in claim 3, wherein the opening of the second sidewall is located at a middle of the second sidewall.
